(19) United States
(12) Patent Application Publication
(10) Pub. No.: US 2010/0047017 A1
(43) Pub. Date: Feb. 25, 2010

(54) METHOD AND DEVICE FOR PREVENTING DUST FORMATION DURING DEMOLITION WORK

(76) Inventor: Martinus Hogenes, Alphen aan den Rijn (NL)

Correspondence Address: KENYON & KENYON LLP, ONE BROADWAY, NEW YORK, NY, 10004, US

(21) Appl. No.: 12/375,372

(22) PCT Filed: Jul. 19, 2007
(86) PCT No.: PCT/NL07/00185

§ 371 Date: Nov. 5, 2009

(30) Foreign Application Priority Data
Jul. 27, 2006 (NL) 2000161

(51) Int. Cl. E01C 23/00; B08B 17/02; E01C 23/088

(52) U.S. Cl. 404/75; 404/90

(57) ABSTRACT

In a method for preventing dust formation and the release of polyaromatic hydrocarbons, quartz particles and asbestos particles, among other substances, during demolition work, at least part of an object, such as the upper layer of a road surface is fragmented into small pieces by a working device and discharged, and a mist is created by a liquid at least around and above the point of contact between the working device and the object, with the mist droplets having a diameter of less than 30 μm.

### FIELD OF THE INVENTION

The present invention relates to a method for preventing dust formation and the release of polyaromatic hydrocarbons (in particular up to EPA16), quartz particles and asbestos particles, among other substances, during demolition work, wherein at least part of an object, such as the upper layer of a road surface is fragmented into small pieces by a working device and discharged.

### BACKGROUND INFORMATION

A method and a device for carrying out such a method are described in European Published Patent Application No. 1 367 176.

In this method, nozzles spray a liquid made up of water and a binding agent onto the working device and the area surrounding the working device. The liquid droplets bind at least part of the dust that is released during the work and subsequently precipitate.

Quartz particles, polyaromatic hydrocarbons, dust and asbestos particles may be released at the location of scarifiers, demolition cranes and road sweepers, for example, and may be carcinogenic in the case of (prolonged) exposure thereto above a particular concentration. Consequently it is desirable to minimize this exposure during the aforesaid demolition work.

A disadvantage of this method is the fact that it does not function optimally and that relatively much liquid is needed in order to effect a substantial dust reduction.

### SUMMARY

Example embodiments of the invention provide a method which is more effective and wherein a greater reduction of dust and/or other harmful substances is achieved and/or wherein said reduction is achieved with less liquid.

According to example embodiments of the present invention, a mist is to that end created by a liquid at least around and above the point of contact between the working device and the object, with the mist droplets having a diameter of less than 30 μm. Since mist droplets of that size remain suspended in the air for some time, the contact time with the dust is significantly longer than is the case with liquid being sprayed, where the liquid droplets precipitate immediately. Furthermore the spacing between the droplets is significantly smaller than in the case of liquid being sprayed, so that a blanket that is impenetrable to dust particles is created.

The mist may be at least partially created in a dome that is disposed above the working device, the working device being, e.g., a cutter drum, which is preferably mounted in a mobile device. The dome encloses a space of 4-10 m³, for example. The fragmented pieces of the object are preferably discharged by a conveying device such as a conveyor belt. The dome in which the mist is created preferably extends to above the conveying device.

The liquid preferably includes water and an additive, which additive preferably includes a binding agent. The liquid preferably includes at least 0.2 ml of binding agent (such as Bitfoam™ from Cleandust BV, or Dustaway™ from BMF BV) per liter of water. The substances are biodegradable and also act as softeners and surface tension reducers. The dust bound to the binding agent generally remains on the ground in bound condition for 4-14 days, by the end of which time it will generally be covered with a new layer already.

The liquid is preferably atomized by atomizing nozzles. With the aforesaid dome volume, the liquid is atomized by, for example, 6-20 atomizing nozzles. Another manner of creating a mist is, for example, evaporating the liquid into steam. The atomizing nozzles are preferably hydraulic atomizing nozzles having a nominal capacity of 2-6 l/hour at a pressure of 2 bar, for example a BEX™ C-series model CL of 3 l/hour at a pressure of 2 bar, or a similar atomizing nozzle. The liquid is preferably pumped through the atomizing nozzles under a pressure of 50-200 bar, which is very high for this kind of atomizing nozzles. Preferably at least 0.3 l, more preferably at least 0.7 l of liquid per cubic meter of dome volume is atomized per minute in that case.

Near the point of contact, liquid may be additionally sprayed to form droplets having size of more than 30 μm, according to European Published Patent Application No. 1 367 176. The droplets precipitate and soften the road surface and the fragments, so that less dust is generated already at the source.

Example embodiments of the present invention also provide a device for carrying out demolition work as described above.

Example embodiments of the present invention are explained in more detail below with reference to the figures.

### BRIEF DESCRIPTION OF THE DRAWINGS

FIG. 1 is a schematic side elevation of an asphalt milling machine.

FIG. 2 is a schematic view of the liquid atomizing system that is used in the machine shown in FIG. 1.

### DETAILED DESCRIPTION

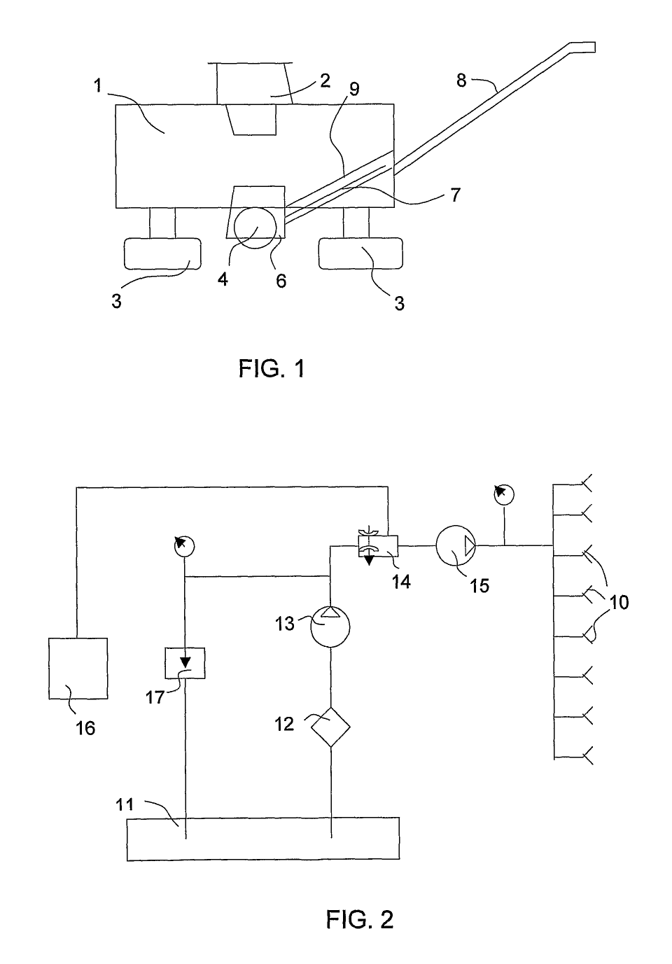

FIG. 1 very schematically shows an asphalt milling machine. Such a machine is known and is shown (FIG. 1) and described in more detail in European Published Patent Application No. 1 367 176.

The asphalt milling machine includes a frame 1 with a driver's cabin 2 and caterpillar tracks 3, by which the machine can be moved. A cutter drum 4 is rotatably mounted to the underside of the machine and can be moved up and down to scrape the top layer from an asphalt road and fragment it into small pieces.

A dome 6, which is open at the bottom side, is arranged around the cutter drum 4, which dome includes a working space in which dust being released upon scarification of the road surface is captured. The working space under the dome has a volume of about 6 m³.

The fragmented pieces of the road surface are discharged from the cutter 4 at the front side of the machine to a collecting container (not shown) moving along the machine by a fixed lower conveyor belt 7 and a pivotable upper conveyor belt 8 connecting thereto. The conveyor belt 7 is enclosed by an extension 9 of the dome 6. The conveyor belt 8 is surrounded by a cover (not shown).

Eight hydraulic atomizer nozzles 10 (see FIG. 2), BEX™ C-series model CL of 3 l/hour at a pressure of 2 bar, are provided in the dome 6 and the extension 9.

According to FIG. 2, the mist atomizers 10 are fed from a water reservoir 11 during scarification of an asphalt road surface. A water pump 13 and a hydraulics pump 15 pump the water to the atomizers 10 under a pressure of about 70 bar via a water filter 12, atomizing in total about 4 liters of liquid per minute in the dome 6 and the extension 9 to form mist droplets having a diameter of less than 30 μm. Arranged between the water pump 13 and the hydraulics pump 15 is an injector 14, where about 0.3-0.5 ml of a biodegradable additive, such as Bitfoam™ or Dustaway™ from an additive reservoir 16 is added per liter of water. A return line provided with a non-return valve 17 carries back excess water to the water reservoir 11.

1-27. (canceled)

28. A method for preventing dust formation and release of substances including polyaromatic hydrocarbons, quartz particles, and asbestos particles during demolition work, comprising:
fragmenting at least part of an object into small pieces by a working device and discharging the pieces; and
creating a by a liquid at least around and above a point of contact between the working device and the object;
wherein mist droplets of the mist have a diameter of less than 30 μm.

29. The method according to claim 28, wherein the object includes an upper layer of a road surface.

30. The method according to claim 28, wherein this mist is at least partially created in a dome that is disposed above the working device.

31. The method according to claim 28, wherein the working device is mounted in a mobile device.

32. The method according to claim 28, wherein said working device includes a cutter drum.

33. The method according to claim 28, wherein the fragmented pieces of the object are discharged by at least one of (a) a conveying device and (b) a conveyor belt.

34. The method according to claim 30, wherein the fragmented pieces of the object are discharged by at least one of (a) a conveying device and (b) a conveyor belt, and the dome extends to above the at least one of (a) the conveying device and (b) the conveyor belt.

35. The method according to claim 28, wherein the liquid includes water and an additive.

36. The method according to claim 35, wherein the additive includes a binding agent.

37. The method according to claim 36, wherein the liquid includes at least 0.2 ml of binding agent per liter of water.

38. The method according to claim 30, wherein the dome encloses a space having a volume of 4-10 m³.

39. The method according to claim 28, wherein the liquid is atomized by atomizing nozzles.

40. The method according to claim 39, wherein the liquid is atomized by at least 6 atomizing nozzles.

41. The method according to claim 39, wherein the atomizing nozzles include hydraulic atomizing nozzles having a nominal capacity of 2 to 6 l/hour at a pressure of 2 bar.

42. The method according to claim 39, wherein the liquid is pumped through the atomizing nozzles under a pressure of 50 to 200 bar.

43. The method according to claim 30, wherein at least one of (a) at least 0.3 l and (b) at least 0.7 l of liquid per cubic meter of dome volume is atomized per minute.

44. The method according to claim 28, further comprising spraying liquid near the point of contact to form droplets having a size of more than 30 μm.

45. A device adapted to carry out demolition work, comprising:
a working device adapted to fragment at least part of an object into small pieces; and
mist device adapted to create a mist, having mist droplets having a diameter of less than 30 μm, by a liquid at least around and above a point of contact between the working device and the object.

46. The device according to claim 45, wherein the object includes an upper layer of a road surface.

47. The device according to claim 45, further comprising a dome arranged above the working device, the mist device arranged to create the mist in the dome.

48. The device according to claim 45, wherein the device is arranged as a mobile device.

49. The device according to claim 45, wherein the working device includes a cutter drum.

50. The device according to claim 45, further comprising at least one of (a) a conveyor device and (b) a conveyor belt adapted to discharge the fragmented pieces of the object.

51. The device according to claim 47, further comprising at least one of (a) a conveyor device and (b) a conveyor belt adapted to discharge the fragmented pieces of the object, wherein the dome extends to above the at least one of (a) the conveyor device and (b) the conveyor belt.

52. The device according to claim 47, wherein the dome encloses a space having a volume of 4 to 10 m³.

53. The device according to claim 45, wherein the mist device includes atomizing nozzles.

54. The device according to claim 53, wherein the mist device includes at least 6 atomizing nozzles.

55. The device according to claim 53, wherein the atomizing nozzles include hydraulic atomizing nozzles having a nominal capacity of 2 to 6 l/hour at a pressure of 2 bar.

56. The device according to claim 45, further comprising additional spray nozzles near the point of contact, the spray nozzles adapted to spray liquid to form droplets having a diameter of more than 30 μm.
